(19) United States
(12) Patent Application Publication
(10) Pub. No.: US 2003/0153283 A1
(43) Pub. Date: Aug. 14, 2003

(54) Mobile phone

(76) Inventor: Yasuyoshi Kuwazoe, Chiba (JP)

Correspondence Address: William S. Frommer, Esq., FROMMER LAWRENCE & HAUG LLP, 745 Fifth Avenue, New York, NY, 10151, US

(21) Appl. No.: 10/338,989

(22) Filed: Jan. 9, 2003

(30) Foreign Application Priority Data
Jan. 11, 2002 (JP) 2002-004216

(51) Int. Cl. H04B 1/38

(52) U.S. Cl. 455/90; 455/566; 455/550

(57) ABSTRACT

In a mobile phone which displays a target information item after sequentially displaying selected information items from an uppermost level to lower levels of a hierarchical tree structure in which a variety of items are classified in accordance with a user's operation, an information item with a high priority for each user is made to be found easily. A main LCD, a sub LCD and a microcomputer for controlling display on the main LCD and the sub LCD are provided. The microcomputer controls so that an information item selected by the user among information items displayed on the main LCD at a time of display selection is always displayed on the sub LCD.

### CROSS REFERENCES TO RELATED APPLICATIONS

The present document is based on Japanese Priority Document JP 2002-004216, filed in the Japanese Patent Office on Jan. 11, 2002, the entire contents of which being incorporated herein by reference.

### BACKGROUND OF THE INVENTION

1. Field of the Invention

The present invention relates to a mobile phone.

2. Description of the Related Art

In accordance with demands for the multifunctional property of mobile phones, information items to be displayed on a mobile phone are increasing. On this account, in a case of displaying “estimated free call time” (time duration included in a basic charge that a user can make calls free of charge) in a mobile phone, an operation including the following steps, as shown in FIG. 7, is required:

(1) Display “MAIN MENU” on a display thereof;

(2) Select “SETTING” from a list of the “MAIN MENU”;

(3) Select “CALL RECORD DATA” from a list of the “SETTING”; and

(4) Select “ESTIMATED FREE CALL TIME” from a list of the “CALL RECORD DATA”.

In this way, in a mobile phone, items to be displayed are hierarchically classified into a plurality of levels. A target information item can be displayed by sequentially proceeding from an uppermost level (“MAIN MENU”) to a lower level indicating the target information. However, the number of the levels varies depending on an item finally selected/displayed. In other words, there may be a case of three levels to reach a target information item A, simultaneously with a case of five levels to reach a target information item B.

### SUMMARY OF THE INVENTION

However, in order to reach a target information item, it is required to press an enter key pointing a cursor on the display to an item to be selected using a cursor key at every level. This is quite troublesome for a user who wants the target information. There may be a case that the user needs a certain information item, and he/she want to indicate the information frequently. In such a case, in particular, the user may feel it troublesome to carry out the steps required for indicating the information each and every time. Besides, since information items of a higher priority vary depending on each user, even if a predetermined information item useful for a certain user is arranged to be displayed by default, the information item may be useless for the other users.

The present invention has been made to solve such conventional problems.

In the present invention, there is provided a mobile phone which displays a target information item after sequentially displaying selected information items in accordance with a user's operation from an uppermost level to lower levels of a hierarchical tree data structure in which a variety of items are classified. The mobile phone comprises a main display device, a sub display device and a controller for controlling display on the main display device and the sub display device. The display is controlled so that an information item selected by the user among information items displayed on the main display device at a time of display selection is always displayed on the sub display device. Accordingly, an information item with a high priority for each user is always displayed on the sub display device of his/her mobile phone.

According to the present invention, even if information items are hierarchically classified, a target information item can be found immediately. In particular, even an information item that a user frequently refers to can be found always with ease. In addition, even if the priority on the information varies depending on the users, it is possible for each user to find an information item which is important for him/her easily without spending much time.

Furthermore, the mobile phone may be made foldable in its overall figure having a main body and a lid portion. In such a case, a detector may be provided to detect whether the mobile phone is opened or folded, that is, the lid portion is opened or closed. Display on the sub display device may be switched in accordance with a detection result. According to the present invention as modified in this way, irrespective of whether the mobile phone is opened or is folded, the displayed information item is visible. In addition, it is also possible to display different information items depending on whether the mobile phone is opened or the mobile phone is folded.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1A and FIG. 1B are front views showing an embodiment of the present invention, respectively;

FIG. 2 is a systematic figure showing the embodiment of the present invention;

FIG. 3 is a hierarchical figure showing the embodiment of the present invention;

FIG. 4A and FIG. 4B are views showing a display screen for explaining the present invention;

FIG. 5A and FIG. 5B are another views showing a display screen for explaining the present invention;

FIG. 6 is a flowchart showing a part of the embodiment of the present invention; and

FIG. 7 is a hierarchical figure for explaining a conventional technique.

### DESCRIPTION OF THE PREFERRED EMBODIMENT

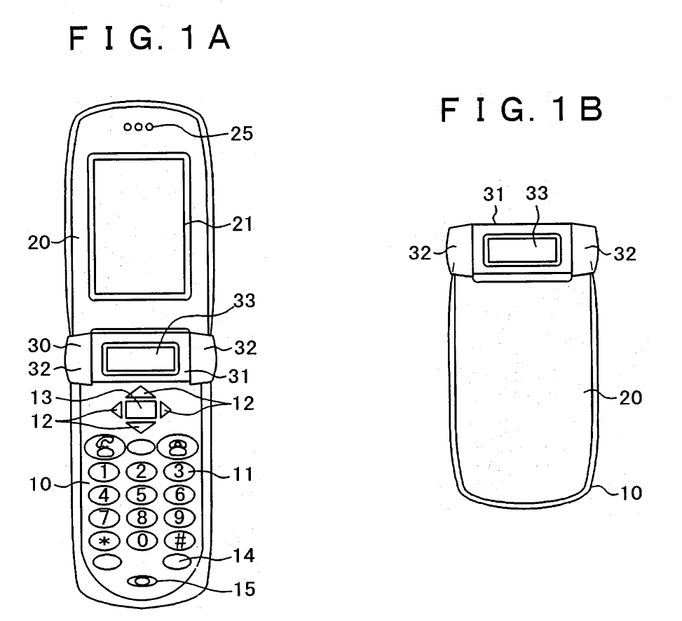

FIGS. 1A and 1B show a case where the present invention is applied to a foldable mobile phone, such as a clamshell type handset. FIG. 1A is a front view showing a status of the handset being opened and FIG. 1B is a front view showing a status of the handset being folded.

The mobile phone comprises a main body 10 and a lid portion 20. Each of the main body 10 and the lid portion 20 is constituted to be flat and almost rectangular parallelepiped in its overall figure. In addition, the main body 10 and the lid portion 20 are integrally assembled to be foldable with a hinge 30.

In order to constitute the hinge 30, in a case of FIG. 1A, the width of an upper portion 31 of the main body 10 in FIG. 1A is made narrower and a pair of leg portions 32, 32 are integrally provided to both sides of a lower portion of the lid portion 20 in FIG. 1A. The leg portions 32, 32 are positioned at both sides of the upper portion 31 of the main body 10, and, for example, an axis (not shown) penetrating the leg portions 32, 32 and the upper portion 31 is provided. Thus, the lid portion 20 is made freely foldable or freely openable/closable with regard to the main body 10.

Although not shown in the figure, the hinge 30 is provided with a clicking mechanism. In a state of the mobile phone being opened, the lid portion 20 and the main body 10 are locked to be almost flat. In a state of the mobile phone being folded, the lid portion 20 and the main body 10 are locked folded.

Operation keys including numerical keys 11, cursor keys 12, an enter key 13 and special keys 14 are arranged on a front face of the main body 10, that is, a surface facing the lid portion 20. A microphone 15 is also provided on the front face of the main body 10 at a lower part in FIG. 1A. In addition, an LCD (Liquid Crystal Display) 21 is provided as a main display device on a front face of the lid portion 20, that is, a surface facing the main body 10. A receiver 25 is also provided on the front face of the lid portion 20 at an upper part in FIG. 1A.

Furthermore, since the hinge 30 comprises the upper portion 31 with the narrow width and the leg portions 32, 32 as mentioned above, it is possible for a user to see a front face of the upper portion 31 regardless of whether the mobile phone is opened or folded. Thus, there is provided an LCD 33 as a sub display device at the front face of the upper portion 31.

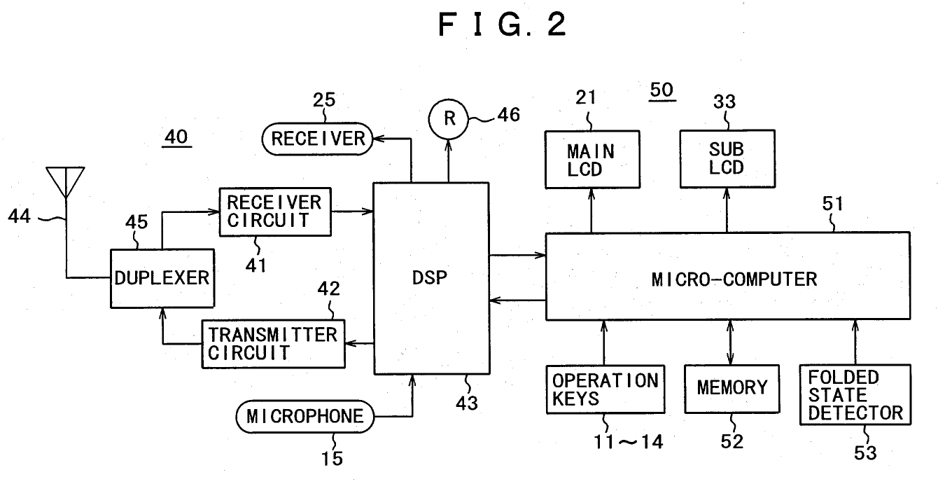

In addition, a telephone circuit 40 and a control circuit 50 as shown in FIG. 2, for example, are provided inside the main body 10 and the lid portion 20. The telephone circuit 40 may include a receiver circuit 41, a transmitter circuit 42 and a DSP (Digital Signal Processor) 43 constituting a codec circuit. A downstream transmit wave from a base station is received by a transmitter/receiver antenna 44, and a received signal is supplied to the receiver circuit 41 through a duplexer 45 and a predetermined digital signal is demodulated to be picked up. Subsequently, the digital signal is supplied to the DSP 43 so that a voice signal of the other party is also picked up, and the voice signal is supplied to the receiver 25. Additionally, the DSP 43 also has a ringer 46 connected thereto for notifying receiving of a call.

Furthermore, the voice signal from the microphone 15 is supplied to the DSP 43 to be converted to a predetermined digital signal. The digital signal is supplied to the transmitter circuit 42 to be an upstream transmit signal, and the transmit signal is supplied to the transmitter/receiver antenna 44 through the duplexer 45 to be transmitted to the base station.

The control circuit 50 may include the above-mentioned operation keys 11-14, the main LCD 21, the sub LCD 33 and a microcomputer 51 constituting a system controller. At the time of call-out, call-in and the like, a control signal corresponding to the situation accesses the base station and the mobile phone. Accordingly, a control signal transmitted from the base station is picked up from the DSP 43 to be supplied to the microcomputer 51, and a control signal to be transmitted to the base station is supplied from the microcomputer 51 to the DSP 43 so as to be transmitted to the base station.

A memory 52 and a folded-state detector 52 as well as the operation keys 11-14, the main LCD 21 and the sub LCD 33 are connected to the microcomputer 51. In this case, the memory 52 is used for storing various data such as telephone numbers of call destinations (telephone book), call record and the like, and it comprises a non-volatile memory. In addition, the folded-status detector 53 is used for detecting whether the lid portion 20 is opened (as in FIG. 1A) or it is closed (as in FIG. 1B). The detector 53 may comprises a switch working with the open/close operation of the lid portion 20, for example.

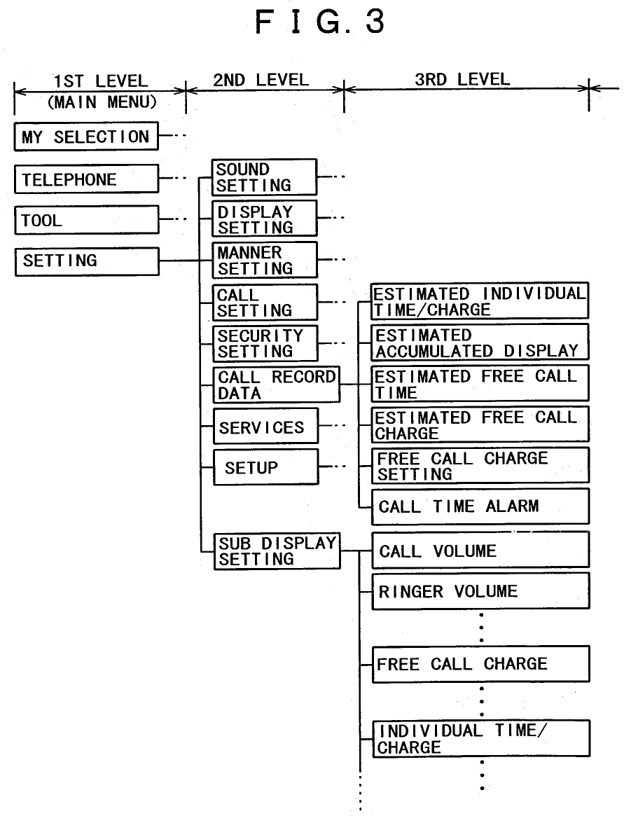

In addition, in this mobile phone, it is possible to execute information display or setting in accordance with such a hierarchical tree structure as shown in FIG. 3, for example, if the microcomputer 51 executes a predetermined routine.

After execution of the following steps:

(I) Display “MAIN MENU” on the main LCD 21;

(II) Select “SETTING” from a list of the “MAIN MENU”;

(III)Select “CALL RECORD DATA” from a list of the “SETTING”; and

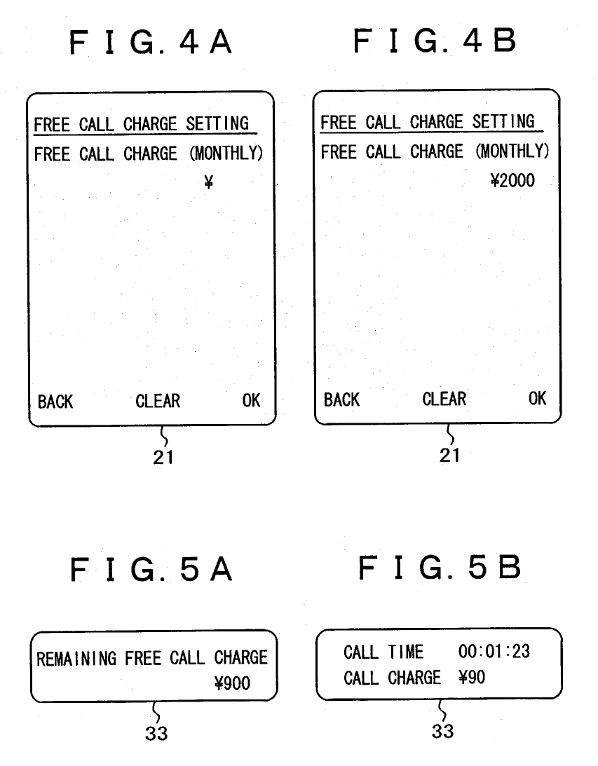

(IV) Select “FREE CALL CHARGE SETTING” from a list of the “CALL RECORD DATA”, an input screen as shown in FIG. 4A is displayed on the main LCD 21, and a free call charge, that is, an amount that a user can make calls with no charge, in this case, ¥2,000, can be entered through the numerical keys 11, as in FIG. 4B.

In other words, while the mobile phone is on standby, when any key among the operation keys 11-14 is pressed, a first level of the hierarchical tree structure shown in FIG. 3 is displayed on the main LCD 21 as a main menu. Subsequently, after a cursor is positioned at a desired item using the cursor key 12 and the enter key is pressed, a second level menu included in the item on which the cursor is positioned is displayed on the main LCD 21. In the similar way, operating the keys 11-12 to proceed to a lowermost level enables display of a target information item on the main LCD 21 and any data may be entered depending on the items.

On the other hand, for example, in a case of easily displaying the information item of “FREE CALL CHARGE”, the keys 11 and 12 are operated as described above, and the following steps are executed:

(A) Display “MAIN MENU” on the LCD 21;

(B) Select “SETTING” from a list of the “MAIN MENU”;

(C) Select “SUB DISPLAY SETTING” from a list of the “SETTING”; and

(D) Select “FREE CALL CHARGE” from a list of the “SUB DISPLAY SETTING”.

Accordingly, the item displayed on the sub LCD 33 is set to “FREE CALL CHARGE”, and, for example, as shown in FIG. 5A, remaining free call charge, that is a part not consumed yet, of the set free call charge is displayed on the sub LCD 33. In the case of FIG. 5, another ¥900 is included in the basic charge and the user can make a call which is worth as much as ¥900 at no charge.

Similarly, if an item of “INDIVIDUAL TIME/CHARGE” is selected from a list of the “SUB DISPLAY SETTING” in the hierarchical tree structure of FIG. 3, the item to be displayed on the sub LCD 33 is set to the “INDIVIDUAL TIME/CHARGE”, and, for example, as shown in FIG. 5, a call time and a call charge thereof of a latest call is displayed on the sub LCD 33. The item displayed on the sub LCD 33 is continued to be displayed until the user selects another item to be displayed or nondisplay, in other words, the item is always displayed.

According to the mobile phone described above, since the user can select an item from the list in the menu and make it always displayed on the sub LCD 33, it is possible for the user to find the target information item at once, and, in particular, to find always with ease an item that the user frequently want to check. In addition, even if the priority on the information varies depending on the users, it is possible for each user to find information data which is important for him/her easily without spending much time.

Furthermore, since the lid portion 20 is connected to the main body 10 through the hinge 30, as shown in FIGS. 1A and 1B, the display content on the sub LCD 33 is visible regardless of whether the lid portion 20 is opened or closed. In addition, there may be a case where different information items are displayed on the sub LCD 33 depending on whether the lid portion 20 is opened or closed, in accordance with a detection result output from the folded state detector 54. For example, when the lid portion 20 is held opened, free call time is displayed on the sub LCD 33, while current time is displayed, when the lid portion 20 is closed, that is, the mobile phone is folded.

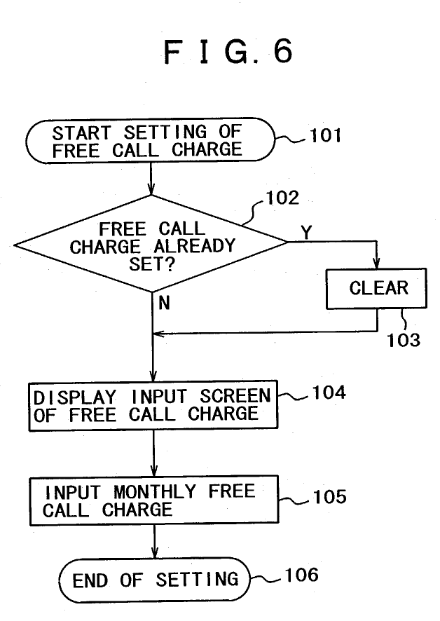

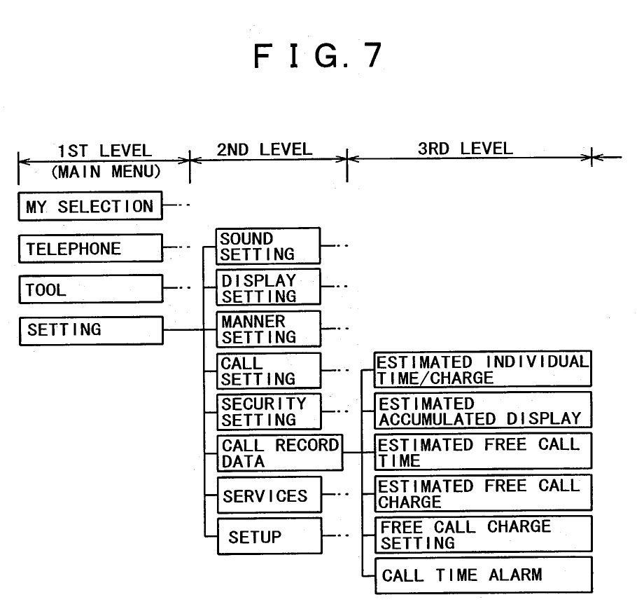

FIG. 6 shows one example of a routine that the microcomputer 51 executes when free call charge as shown in FIG. 4 is set. In other words, when the “FREE CALL CHARGE SETTING” is selected in the hierarchical tree structure in FIG. 3, a processing of a CPU (Central Processing Unit)(not shown) in the microcomputer 51 starts from a step 101 in the routine shown in FIG. 6. Next, at a step 102, whether or not the free call charge has been already set is determined. When the free call charge is not set yet, the process goes from the step 102 to a step 104. When the free call charge has been already set, the process goes from the step 102 to a step 103, and, after the free call charge already set is cleared, the process goes to the step 104.

In the step 104, as shown in FIG. 4A, an input screen for the free call charge is displayed on the main LCD 21. Next, in a step 105, the display is standby for an input of the free call charge. The user, then, can enter his/her free call charge corresponding to his/her contracting billing plan.

The user can enter the input through the numerical keys 11. In a case of input error, an erroneous input may be cleared by moving the cursor onto the characters “CLEAR” on the main LCD 21 using the cursor key 12 and pressing the enter key 13. In addition, when the cursor is positioned on the characters “BACK” using the cursor key 12 and the enter key 13 is pressed, the input of the free call charge is cancelled and the display goes back to the main menu.

And when a correct amount of charge is entered, by moving the cursor onto the characters “OK” using the cursor key 12 and pressing the enter key 13, the free call charge entered in the step 105 is set in the microcomputer 51. After that, the routine is completed at a step 106 and the display goes back to the main menu screen.

According to the routine shown in FIG. 6, even in a case where the free call charge varies depending on plans the users contracting, the user can set his/her own free call charge corresponding to his/her contracting plan.

In the embodiment, although the cursor key 12 is used for moving the cursor, a jog dial may be used instead of the cursor key 12.

Although the invention has been described in its preferred form with a certain degree of particularity, obviously many changes and variations are possible therein. It is therefore to be understood that the present invention may be practiced otherwise than as specifically described herein without departing from the scope and the sprit thereof.

What is claimed is:

1. A mobile phone which displays a target information item after sequentially displaying selected information items in accordance with a user's operation from an uppermost level to lower levels of a hierarchical tree structure in which a variety of items are classified, comprising:
a main display device;
a sub display device; and
a controller for controlling display on said main display device and said sub display device, wherein:
said controller controls so that an information item selected by the user among information items displayed on said main display device at a time of display selection is always displayed on said sub display device.

2. The mobile phone according to claim 1, wherein:
the information item to be displayed on said sub display device is an information item in one of lowermost levels of said hierarchical tree structure.

3. The mobile phone according to claim 1, comprising:
a main body;
a lid portion engaged to said main body to be foldable; and
a detector for detecting whether or not said mobile phone is folded, wherein:
said main display device is provided on a surface of said lid portion facing said main body;
said sub display device is provided on a surface in said main body not covered with said lid portion; and
the information item displayed on said sub display device is switched in accordance with a detection result output from said detector between a state that said mobile phone is folded and a state that said mobile phone is not folded.

4. A display controlling method in a mobile phone which comprises a main display device, a sub display device and a controller, and displays a target information item after sequentially displaying selected information items in accordance with a user's operation from an uppermost level to lower levels of a hierarchical tree structure in which a variety of items are classified, said method comprising a step of controlling an information item selected by the user among information items displayed on said main display device at a time of display selection to be always displayed on said sub display device.

5. The display controlling method according to claim 4, wherein:
the information item to be displayed on said sub display device is an information item in one of lowermost levels of said hierarchical tree structure.

6. The display controlling method according to claim 4, wherein said mobile phone comprises a main body, a lid portion engaged to said main body to be foldable and a detector for detecting whether or not said mobile phone is folded, in which said main display device is provided on a surface of said lid portion facing said main body and said sub display device is provided on a surface in said main body not covered with said lid portion, said method further comprising a step of switching the information item displayed on said sub display device in accordance with a detection result output from said detector between a state that said mobile phone is folded and a state that said mobile phone is not folded.
